(19) United States
(12) Patent Application Publication
(10) Pub. No.: US 2024/0393448 A1
(43) Pub. Date: Nov. 28, 2024

(54) RADAR SYSTEM AND METHOD FOR DETECTING AN OBJECT IN SPACE

(71) Applicant: NEURA ROBOTICS GMBH, Metzingen (DE)

(72) Inventors: Dmitrii KOZLOV, Wannweil (DE); Josef SIRAKY, Donaueschingen (DE); David REGER, Metzingen (DE)

(21) Appl. No.: 18/692,709

(22) PCT Filed: Sep. 16, 2022
(86) PCT No.: PCT/EP2022/075725

§ 371 Date: Mar. 15, 2024

(30) Foreign Application Priority Data
Sep. 16, 2021 (DE) 10 2021 124 011.5

(51) Int. Cl. G01S 13/42; G01S 7/03; G01S 7/41

(52) U.S. Cl. CPC G01S 13/426; G01S 7/03; G01S 7/411; G01S 13/422

(57) ABSTRACT

The invention relates to a radar system (100) comprising at least one movably arranged localization sensor (1.1, 10.1) which is designed in the form of a radar sensor and comprising means for detecting the position of the at least one localization sensor (1.1, 10.1). The at least one localization sensor (1.1, 10.1) has means for generating a non-homogenous radiation characteristic, said means being designed such that a localization radiation lobe (1.3) formed therewith has a signal amplitude which is based on a first localization angle (50) such that the signal amplitude has a localization signal curve (52), wherein the localization signal curve (52) is based on a second localization angle (54). The invention also relates to a method (800) for detecting an object (8) in space, a second localization component of the reflected localization signal (71) being detected by correlating the reflected signal curve with the non-homogenous radiation characteristic of the localization sensor.

The invention relates to a radar system and a method for detecting an object in space.

To detect, in particular to localize, objects in space, radar sensors are used, which are arranged on a rotor and are therefore arranged to be rotatable about an axis of rotation. The azimuth angle of a reflected signal captured by the radar sensor can be detected via the position of the rotor. The azimuth angle corresponds to the azimuth position of an object in space from which the signal is reflected. To detect the elevation angle, it is known to use a radar sensor with several receiving antennas arranged at a distance from one another. The elevation angle of the reflected signal can be detected through the phase shifts with which a reflected signal is captured at the various receiving antennas and the known distances between the receiving antennas. In addition, the elevation angle can be detected using the so-called phased array method, in which several transmitting antennas are used and a signal having a specific phase shift is emitted from each transmitting antenna. This allows the propagating transmission beam to be deflected in terms of its direction of propagation.

US 2018/0 267 160 A1 is cited as prior art.

A disadvantage of the known systems and methods is that a large number of transmitting and/or receiving antennas are required to detect the elevation angle, which is associated with a high level of system complexity. The processing of the transmission and receiving signals is correspondingly complex. An improvement in the resolution of a system is associated with a further increase in complexity. Conventional radar systems are therefore expensive.

The invention is therefore based on the object of providing a radar system with which an object in space can be reliably and precisely detected and which has low development, manufacturing and operating costs.

The invention is also based on the object of providing a method with which an object in space can be reliably and precisely detected and which is easy to implement.

The object is achieved according to the invention by a radar system with the features of claim 1, a method with the features of claim 17, and a radar system with the features of claim 26.

Advantageous configurations and refinements of the invention are set forth in the dependent claims.

A radar system according to the invention has at least one localization sensor, wherein the at least one localization sensor is designed as a movably arranged radar sensor. The localization sensor can be designed to transmit and/or receive. Because the localization sensor is movably arranged, a large area can be scanned. In addition, a radar system according to the invention has a means for detecting a localization sensor position of the at least one localization sensor. The at least one localization sensor has a means for generating a non-homogeneous radiation characteristic, said means being designed such that a localization radiation lobe formed therewith has a signal amplitude that is based on a first localization angle, such that the signal amplitude has a localization signal curve. The localization signal curve is based on a second localization angle. The localization signal curve preferably describes the curve of the signal amplitude as a function of the first localization angle for a second localization angle.

The signal amplitude can be plotted in an antenna diagram as a function of the first localization angle and the second localization angle. To determine the signal amplitude of the localization sensor, the localization radiation lobe is preferably directed at a reference object, whereby the signal amplitude can be detected based on the reflected signal. Because the radiation characteristic is non-homogeneous, it can preferably have an irregular course in the direction of the first localization angle and/or in the direction of the second localization angle. Preferably, the second localization angle can be inferred from the localization signal curve due to the non-homogeneity of the radiation characteristic. The signal amplitude can be designed as a complex signal amplitude, the complex signal amplitude preferably having the signal amplitude and a signal phase.

Preferably, the first localization angle is arranged in an azimuth direction and the second localization angle is arranged in an elevation direction. Here and below, the direction of rotation about a vertical axis is preferably referred to as the azimuth direction. An azimuth angle can accordingly describe the angle between two points on a horizontal plane with respect to the vertical axis. The localization sensor is preferably designed rotatably about the vertical axis, i.e., rotatably in the azimuth direction. Here and below, the direction of rotation about a horizontal axis is preferably referred to as the elevation direction. An elevation angle can describe the angle between two points in a vertical plane with respect to a horizontal axis.

Preferably, the radiation characteristic is so non-homogeneous that a correlation of the localization signal curves of different second localization angles results in a maximum value of less than or equal to 0.5, preferably less than or equal to 0.3, particularly preferably less than or equal to 0.1. This makes it possible to provide a radiation characteristic which has comparatively dissimilar localization signal curves for different second localization angles and thus a high degree of non-homogeneity. As a result, a specific localization signal curve can be assigned relatively reliably to a specific second localization angle.

The means for generating a non-homogeneous radiation characteristic can be formed by a cover. The cover is preferably arranged in front of the at least one localization sensor. The cover can in particular be made of plastic. The cover can represent a simple way of producing the non-homogeneity of the localization radiation lobe. The cover can have different thicknesses and/or structures across its surface. In particular, the structure and/or the thickness can correspond to the signal amplitude.

In a refinement of the invention, the means for generating a non-homogeneous radiation characteristic can be formed by a transmitting and/or receiving antenna with an antenna array with a plurality of antenna elements, the individual antenna elements being at least partially arranged at irregular distances from one another, and/or are oriented differently, and/or are at least partially arranged in different planes. By arranging the antenna elements in this way, the non-homogeneity of the radiation characteristic can be achieved. The antenna elements can in particular have different rotational orientations.

The localization radiation lobe is preferably designed such that it has a second opening angle of at least 90°, preferably of at least 120°, and the ratio of the second opening angle of the localization radiation lobe to a first opening angle of the localization radiation lobe is more than 5:1, preferably more than 10:1. The localization radiation lobe can thus have an elliptical or approximately rectangular cross section. Preferably, the second opening angle is arranged in the elevation direction and the first opening angle is arranged in the azimuth direction. As a result, the long side of the cross section of the localization radiation lobe is preferably arranged in the vertical direction. Locating objects in space requires in particular a high resolution and the highest possible update rate. This can be achieved by the movable arrangement and the geometry of the localization radiation lobe. The localization sensor can achieve a high resolution, particularly due to the relatively narrow cross section of the localization radiation lobe.

Preferably, the at least one localization sensor is arranged on a rotor, the rotor is arranged rotatably relative to a stator, and the means for detecting a localization sensor position is designed to capture the position of the rotor relative to the stator.

Preferably, the means for detecting a localization sensor position is formed by an encoder system with at least one reading head and a material measure. The encoder system is preferably arranged on the radar system such that the at least one reading head is arranged on the rotor and the material measure is arranged on the stator. The encoder system particularly preferably has a first reading head and a second reading head. As a result, the encoder system can be designed to be at least partially redundant.

In a refinement of the invention, the radar system has a first localization sensor and a second localization sensor, which are preferably arranged on the rotor with an offset of 180°, particularly in the azimuth direction. This allows the update rate of the radar system to be increased. In addition, redundancy can be created and thus greater reliability can be achieved. Preferably, the first reading head is assigned to the first localization sensor and the second reading head is assigned to the second localization sensor. The localization radiation lobes of the first localization sensor and the second localization sensor can be designed to be at least approximately identical or different.

The radar system can have a localization computing unit which is designed to detect a first localization component, a second localization component and a distance value of a reflected localization signal. The reflected localization signal is preferably the signal that is reflected by an object in space due to the emitted localization radiation lobe. Preferably, the reflected localization signal is captured by the localization sensor and processed by the localization computing unit. Because the radiation characteristic of the localization sensor is designed to be non-homogeneous, the second localization angle of the reflected localization signal and thus the position of the reflecting object can be inferred from the localization signal curve of the reflected localization signal. The detection of the first localization component can be detected in particular based on the detected localization sensor position. In particular, the transit time between emitting the localization signal and detecting the reflected localization signal can be used to detect the distance value. For this purpose, the localization computing unit is preferably connected to the at least one localization sensor and the means for detecting the localization sensor position. The localization computing unit is preferably arranged on the rotor. The radar system can have a rotary feedthrough to connect supply and data lines between the rotor and the stator.

In addition, the radar system can have a first localization computing unit and a second localization computing unit as further redundancy and to further increase the reliability of the radar system.

In a preferred embodiment of the invention, the first localization component is formed by an azimuth angle and the second localization component is formed by an elevation angle. In particular, if the at least one localization sensor is arranged rotatably, a clear description of a position can be provided.

In a preferred embodiment of the invention, the at least one localization computing unit is designed to compare a second reflected localization signal with a first reflected localization signal that has the same first localization component, and to further process only differing signal components. The environment scanned with the localization sensor can have static objects relative to the localization sensor, the reflected localization signal of which does not change or changes insignificantly over time. By comparing the second reflected localization signal with the first reflected localization signal, the static objects can be separated from objects moving relative to the localization sensor. In addition, the comparison can reduce the amount of data to be transmitted and further processed. This allows the dynamics and accuracy of the radar system in particular to be increased. Preferably, the localization computing unit is designed such that a comparison is carried out with every movement cycle, for example with every revolution, of the localization sensor.

In a refinement of the invention, the radar system has at least one identification sensor for identifying an object, wherein an identification radiation lobe can be generated by means of the at least one identification sensor, and wherein the at least one identification sensor is designed as a fixed radar sensor. The identification of an object is preferably carried out by means of the characteristic radar signature generated by an object. The radar signature can comprise a spectrum of Doppler frequencies, the so-called Doppler signature, which can be used to distinguish between living and non-living objects at a high resolution. The high resolution with regard to the Doppler signature requires a comparatively long observation time, which can be contrary in particular to the high update rate for localizing the object. Because the radar system has the at least one rotatable localization sensor and preferably the at least one fixed identification sensor, the radar system can provide ideal conditions for simultaneous localization and identification of an object in space.

The identification radiation lobe preferably has a first opening angle of at least 90°, particularly preferably of at least 120°, and the identification radiation lobe preferably has a second opening angle of at least 90°, particularly preferably of at least 120°. The identification radiation lobe therefore preferably has a circular or approximately square cross section. Furthermore, the first opening angle and the second opening angle of the identification radiation lobe are comparatively large, so that a large area can be captured by means of an identification sensor.

The at least one identification sensor is preferably arranged on the stator. This allows a simple and uniform structure of the radar system to be realized.

In a refinement of the invention, the radar system has a first identification sensor and a second identification sensor, which are preferably arranged on the stator with an offset of 180°, particularly in the azimuth direction. This allows objects to be identified over a large area. Furthermore, the radar system can have additional identification sensors in order to be able to cover an even larger area. The identification radiation lobes of the various identification sensors can be designed to be at least approximately identical or different.

The radar system can have at least one identification computing unit that is designed to identify a radar signature of a reflected identification signal. For this purpose, the radar system can in particular be designed to assign the Doppler signature of the reflected identification signal to a specific object. In particular, the identification computing unit can be designed to compare the radar signatures of the reflected identification signals with a reference database. The at least one identification computing unit is preferably connected in particular to the at least one identification sensor. The at least one identification computing unit can be arranged on the stator.

In addition, the radar system can have a first identification computing unit and a second identification computing unit as further redundancy and to further increase the reliability of the radar system.

The radar system can have a central computing unit which is designed to assign the reflected identification signal to the reflected localization signal. This allows the radar system to locate and simultaneously identify an object in space with high resolution. For this purpose, the central computing unit is preferably connected to at least one localization computing unit and the at least one identification computing unit. In order to be able to assign the reflected identification signal to the reflected localization signal, the at least one identification sensor is preferably designed such that it can at least approximately localize an object based on the reflected identification signal. Preferably, the at least one identification sensor has a transmitting antenna and at least two receiving antennas. As a result, the reflected identification signal can be processed using a beamforming method, preferably by the at least one identification computing unit. The localization of the object based on the reflected identification signal can be significantly less precise than the localization based on the reflected localization signal.

A method according to the invention for detecting an object in space by means of at least one radar sensor designed as a localization sensor, arranged movably and having a non-homogeneous radiation characteristic comprises the following steps:
emitting a localization radiation lobe,
simultaneous capturing a reflected localization signal having a reflection amplitude and an associated localization sensor position,
repeating the aforementioned steps several times while the localization sensor changes its localization sensor position,
creating a reflection signal curve from the reflection amplitudes and the associated localization sensor positions,
detecting a second localization component by correlating the reflection signal curve with the non-homogeneous radiation characteristic of the localization sensor.

If there is a feature in the description of the radar system explained above that corresponds to one of the present features mentioned with regard to the method and has an identical name, the explanations described with regard to the radar system preferably apply in the same way to the present features of the method. For example, the above statements regarding the localization sensor, the localization radiation lobe or the non-homogeneous radiation characteristic of the radar system can apply correspondingly to the localization sensor, the localization radiation lobe or the non-homogeneous radiation characteristic of the method.

Preferably, the at least one localization sensor is arranged movably such that it is designed rotatably. This way, the localization radiation lobe can be emitted frequently during a movement cycle, in particular one revolution, of the localization sensor that an object reflecting the localization signal is hit by the localization radiation lobe several times in succession in the course of a movement cycle of the localization sensor. The localization signal reflected by the object and the associated localization sensor position are preferably captured correspondingly frequently. In addition, the cross section of the object in the direction of movement of the at least one localization sensor can be smaller than the corresponding cross section of the localization radiation lobe, so that the reflection amplitude captured in one step only reflects a section of a signal amplitude of the emitted localization radiation lobe. A reflection amplitude curve can be determined from the flexion amplitudes of the individual reflected localization signals and the associated localization sensor positions. The reflection amplitude curve is preferably designed to be characteristic such that a second localization component can preferably be unambiguously assigned to it with a high degree of probability through correlation with the radiation characteristic. The second localization component is preferably identified by an extremum, in particular a maximum value, in the correlation result. The radiation characteristic can be known from the antenna diagram of the localization sensor.

A first localization component of the respective reflected localization signal is preferably detected using the associated localization sensor position. The distance value can be detected in particular from the transit time of the reflected localization signal. The distance of the reflecting object is preferably detected from the localization signals reflected by the object, in particular based on the transit time and/or the phase shift between transmitting the respective localization signal and capturing the associated reflected localization signal.

The second localization component is preferably formed by an elevation angle. This can in particular take into account the geometry of the localization radiation lobe with certain opening angles. The first localization component can be formed by an azimuth angle. In particular, if the at least one localization sensor is arranged rotatably, a position in space can advantageously be described.

The method can be designed such that the localization radiation lobe is emitted and/or the reflected localization signal is captured by means of the at least one localization sensor. As a result, the localization sensor can impose its non-homogeneous radiation characteristic on the emitted localization radiation lobe and/or the reflected localization signal. If the localization radiation lobe is already emitted by means of the at least one localization sensor, the localization radiation lobe already has a non-homogeneity corresponding to the radiation characteristic of the at least one localization sensor. If only the reflected localization signal is captured by means of the at least one localization sensor, only the reflected localization signal or the reflection signal curve created therefrom has a non-homogeneity corresponding to the radiation characteristic of the at least one localization sensor. If the localization radiation lobe is emitted and the reflected localization signal take is captured by means of the at least one localization sensor, the reflection signal curve can have a particularly strong non-homogeneity. This makes it possible to achieve a particularly reliable correlation result and a high resolution, particularly of the second localization component. The non-homogeneous radiation characteristic can be achieved by capturing the localization signals reflected from a reference object. The second localization component is preferably detected by correlating the reflection signal curve with the radiation characteristic determined in this way.

The method is preferably designed such that a second reflected localization signal is compared with a first reflected localization signal that has the same first localization component. According to the above description of the radar system, the amount of data to be transmitted and further processed can be reduced and the identification of moving objects can also be simplified.

In a preferred embodiment of the method, the reflection amplitude is designed as a complex reflection amplitude, the complex reflection amplitude having the reflection amplitude and a reflection phase. This allows the reflection amplitude to contain additional information. In this way, in particular, the quality of the result of the correlation of the reflection amplitude with the radiation characteristic can be improved.

The method is preferably designed such that it additionally has the following steps:
emitting an identification radiation lobe by means of a fixed radar sensor designed as an identification sensor,
capturing a reflected identification signal having a radar signature,
identifying the radar signature,
assigning the reflected identification signal to the reflected localization signal.

The radar signature can comprise a spectrum of Doppler frequencies, the so-called Doppler signature, which may enable distinguishing between living and non-living objects at a high resolution. The radar signature is preferably identified using the Doppler signature. Identifying the radar signature can in particular comprise comparing the reflected identification signals with a reference database.

In order to be able to assign the reflected identification signal to the reflected localization signal, the reflecting object can be at least approximately localized based on the reflected identification signal. For this purpose, the reflected identification signal is preferably processed by means of a beamforming method. In doing so, the localization of the object based on the reflected identification signal can be significantly less precise than the localization based on the reflected localization signal.

The radar system described above is preferably designed to carry out the method explained.

An exemplary embodiment of the invention is explained using the following figures. In the figures:

FIG. 1 shows a schematic representation of an exemplary embodiment of a radar system,

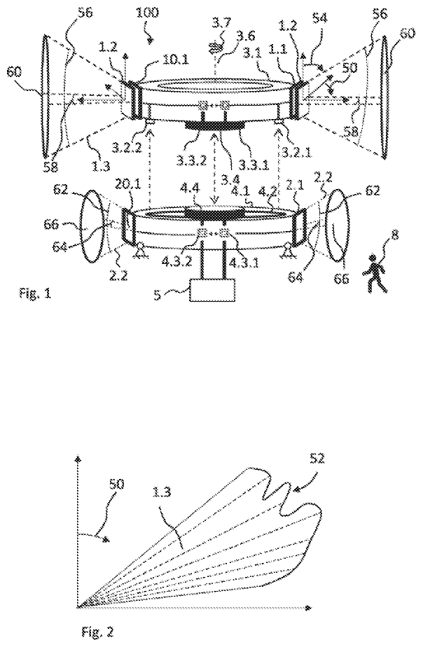

FIG. 2 shows a schematic representation of a projection of a localization radiation lobe onto an azimuth plane,

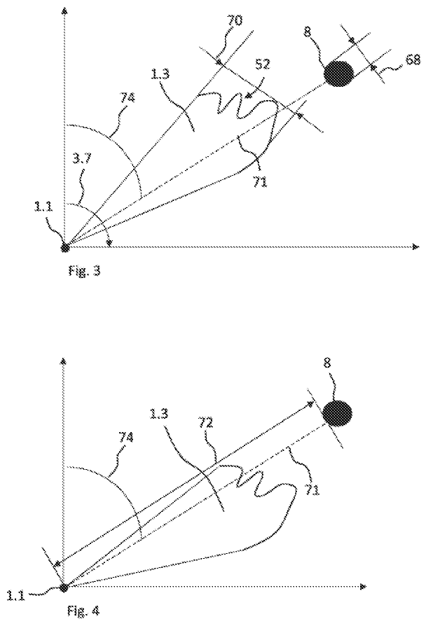

FIG. 3 shows a schematic representation of an arrangement of the localization radiation lobe shown in FIG. 2 in a first azimuth position, and a reflecting object,

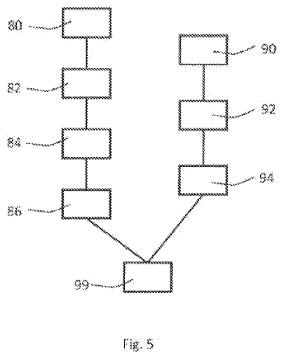

FIG. 4 shows a schematic representation of the arrangement shown in FIG. 3, with the localization radiation lobe being arranged in a second azimuth position,

FIG. 5 shows a schematic representation of a method for detecting an object in space.

The same reference numerals are used for identical and functionally identical parts.

FIG. 1 shows a radar system 100 with a first localization sensor 1.1 and a second localization sensor 10.1, wherein preferably the first localization sensor 1.1 and the second localization sensor 10.1 are designed as rotatable radar sensors. Preferably, the first localization sensor 1.1 and the second localization sensor 10.1 are identical. The first localization sensor 1.1 and the second localization sensor 10.1 can be arranged on a rotor 3.1. The first localization sensor 1.1 and the second localization sensor 10.1 can be arranged with an offset of 180° in the azimuth direction, and thus preferably opposite one another on rotor 3.1. Rotor 3.1 can be arranged rotatably about an axis of rotation 3.6 in an azimuth direction 3.7 relative to a stator 4.1. Because the localization sensors 1.1, 10.1 are rotatably arranged, a large area, preferably of 360°, can be scanned.

In addition, the radar system 100 can have an encoder system with a first reading head 3.2.1, a second reading head 3.2.2 and a material measure 4.2. The encoder system is preferably designed to capture the azimuth position of rotor 3.1 relative to stator 4.1. This allows the localization sensor positions of localization sensors 1.1, 10.1 to be determined by means of the encoder system. The encoder system is preferably arranged on radar system 100 such that first reading head 3.2.1 and second reading head 3.2.2 are arranged on rotor 3.1 and material measure 4.2 is arranged on stator 4.1. First reading head 3.2.1 is preferably assigned to first localization sensor 1.1 and second reading head 3.2.2 is assigned to second localization sensor 10.1.

By means of each of first localization sensor 1.1 and second localization sensor 10.1, a localization radiation lobe 1.3 with a transmission amplitude can be generable. In this case localization radiation lobes 1.3 of first localization sensor 1.1 and second localization sensor 10.1 can be designed to be at least approximately identical or different.

A schematic representation of a projection of localization radiation lobe 1.3 onto an azimuth plane is shown in FIG. 2. The signal amplitude is based on a first localization angle 50, which is preferably arranged in the azimuth direction. As a result, the signal amplitude can have a localization signal curve 52. Here, localization signal curve 52 is based on a second localization angle 54, with elevation angle 54 preferably being arranged perpendicular to first localization angle 50 and thus preferably in the elevation direction (see FIG. 1). The radiation characteristic of localization sensors 1.1, 10.1 can be designed to be non-homogeneous, so that the localization radiation lobes 1.3 emitted by means of the localization sensors 1.1, 10.1 are preferably also designed to be non-homogeneous.

Preferably, the radiation characteristic is so non-homogeneous that a correlation of localization signal curves 52 of different second localization angles 54 results in a maximum value of less than or equal to 0.5, preferably less than or equal to 0.3, particularly preferably less than or equal to 0.1. This makes it possible to provide a radiation characteristic which has comparatively dissimilar localization signal curves 52 for different second localization angles 54 and thus a high degree of non-homogeneity. As a result, a specific localization signal curve 52 can be assigned relatively reliably to a specific second localization angle 54.

As shown in FIG. 1, localization sensors 1.1, 10.1 can have a cover 1.2 to generate the non-homogeneous transmission amplitude. The cover 1.2 can in particular be made of plastic. The cover 1.2 can represent a simple way of producing the non-homogeneity of the radiation characteristic of localization sensors 1.1,0 [sic] 10.1. Cover 1.2 can have different thicknesses and/or structures across its surface. In particular, the structure and/or the thickness can correspond to the transmission amplitude.

Localization radiation lobe 1.3 is preferably designed such that it has a second opening angle 56 of at least 90°, preferably of at least 120°, and the ratio of second opening angle 56 of localization radiation lobe 1.3 to a first opening angle 58 of localization radiation lobe 1.3 is more than 5:1, preferably more than 10:1. Localization radiation lobe 1.3 can thus have an elliptical or approximately rectangular cross section 60, the long side of which is arranged in the vertical direction. In particular, due to relatively narrow cross section 60 of localization radiation lobe 1.3, localization sensors 1.1, 10.1 can achieve a high resolution.

Radar system 100 can have a first localization computing unit 3.3.1, which is designed to detect a first localization component, a second localization component and a distance value 72 (see FIG. 4) of a reflected localization signal 71.

The first localization component is preferably formed by an azimuth angle 74, and the second localization component is formed by an elevation angle. Radar system 100 preferably has a second localization computing unit 3.3.2 as redundancy, which corresponds to first localization computing unit 3.3.1. Reflected localization signal 71 is preferably the signal that is reflected by an object 8 in space due to localization radiation lobe 1.3 emitted by one of localization sensors 1.1, 10.1.

Preferably, the reflected localization signal 71 is captured by one of localization sensors 1.1, 10.1 and processed by first localization computing unit 3.3.1 and second localization computing unit 3.3.2. Because the localization sensors 1.1, 10.1 have a non-homogeneous radiation characteristic, the elevation angle of the reflected localization signal 71 and thus of the reflecting object 8 can also be inferred from the characteristic of the reflected localization signal 71. The detection of azimuth angle 74 can be detected in particular based on the localization sensor positions captured by the encoder system. For this purpose, localization computing units 3.3.1, 3.3.2 are preferably connected to localization sensors 1.1, 10.1 and the encoder system, preferably to reading heads 3.2.1, 3.2.2. Localization computing units 3.3.1, 3.3.2 are preferably arranged on rotor 3.1. Localization computing units 3.3.1, 3.3.2 can be designed to compare a second reflected localization signal with a first reflected localization signal that has the same azimuth angle 74 and to further process only differing signal components. This allows static objects 8 to be separated from objects 8 moving relative to localization sensors 1.1, 10.1. In addition, the comparison can reduce the amount of data to be transmitted and further processed.

Radar system 100 can have a rotary feedthrough with a rotor-side rotary feedthrough part 3.4 and a stator-side rotary feedthrough part 4.4 for carrying out supply and data lines between rotor 3.1 and stator 4.1.

Radar system 100 can have a first identification sensor 2.1 and a second identification sensor 20.1 for identifying object 8, wherein an identification radiation lobe 2.2 can be generated by means of the identification sensors 2.1, 20.1. Here, identification radiation lobes 2.2 of first identification sensor 2.1 and second identification sensor 20.1 can be designed to be at least approximately identical or different. Identification sensors 2.1, 20.1 are preferably designed as fixed radar sensors and arranged on stator 4.1. Preferably, first identification sensor 2.1 and second identification sensor 20.1 are arranged on the rotor with an offset of 180°, particularly in the azimuth direction. This allows objects 8 to be identified over a large area.

Identification radiation lobes 2.2 preferably have a first opening angle 64 of at least 90°, particularly preferably of at least 120°, and a second opening angle 62 of at least 90°, particularly preferably of at least 120°. Thus, identification radiation lobes 2.2 preferably have a circular or approximately square cross section 66. Furthermore, first opening angle 64 and second opening angle 62 of identification radiation lobes 2.2 are therefore comparatively large, so that a large area can be captured by means of one of identification sensors 2.1, 20.1.

Radar system 100 can have a first identification computing unit 4.3.1 and a second identification computing unit 4.3.2, each of identification computing units 4.3.1, 4.3.2 being designed to identify a radar signature of a reflected identification signal. Identification computing units 4.3.1, 4.3.2 are preferably designed identically. For this purpose, radar system 100 can in particular be designed to assign the Doppler signature of the reflected identification signal to a specific object. In particular, identification computing units 4.3.1, 4.3.2 can be designed to compare the radar signatures of the reflected identification signals with a reference database. Identification computing units 4.3.1, 4.3.2 are preferably connected in particular to identification sensors 2.1, 20.1. Identification computing units 4.3.1, 4.3.2 can be arranged on stator 4.1.

Radar system 100 can have a central computing unit 5, which is designed to assign the reflected identification signal to reflected localization signal 71. This allows radar system 100 to locate an object 8 in space with high resolution and at the same time identify it. For this purpose, central computing unit 5 is preferably connected to localization computing units 3.3.1, 3.3.2 and identification computing units 4.3.1, 4.3.2. In order to be able to assign the reflected identification signal to reflected localization signal 71, identification sensors 2.1, 20.1 are designed so that they can at least approximately localize an object 8 based on the reflected identification signal. Preferably, for this purpose, identification sensors 2.1, 20.1 each have a transmitting antenna and at least two receiving antennas. As a result, the reflected identification signal can be processed by means of a beamforming method, preferably by identification computing units 4.3.1, 4.3.2.

FIG. 5 shows a schematic representation of a method 800 with several method steps for detecting an object in space. Preferably, radar system 100 shown in FIG. 1 is designed to carry out the method. The method is explained below using first localization sensor 1.1. The method can be carried out in a corresponding manner by means of second localization sensor 10.1.

Preferably, in a first method step 80, localization radiation lobe 1.3 having a non-homogeneous transmission amplitude is emitted, for example by means of first localization sensor 1.1. In a second method step 82, a reflected localization signal having a reflection amplitude can be simultaneously captured, for example by means of first localization sensor 1.1 and an associated localization sensor position of first localization sensor 1.1, in particular by means of an encoder system. First method step 80 and second method step 82 can be repeated several times, while first localization sensor 1.1 changes its localization sensor position. For this purpose, first localization sensor 1.1 can rotate about axis of rotation 3.6 in azimuth direction 3.7. Preferably, in a third method step 84, a reflection signal curve is created from the reflection amplitudes and the associated localization sensor positions. In a fourth method step 86, the second localization component, preferably in the form of the elevation angle, of reflected localization signal 71 can be detected by correlating the reflection signal curve with the radiation characteristic of localization sensor 1.1.

As shown in FIGS. 3 and 4, localization radiation lobe 1.3 can be emitted so frequently during one revolution of first localization sensor 1.1 that object 8 reflecting the localization signal is hit by the localization radiation lobe several times in succession over the course of one revolution of localization sensor 1.3. In this regard, FIG. 3 shows localization radiation lobe 1.3 in a first azimuth position, FIG. 4 shows localization radiation lobe 1.3 in a second azimuth position. Object 8 is in the same position in FIGS. 3 and 4.

The localization signal reflected by object 8 and the associated localization sensor position of localization sensor 1.1 are preferably captured correspondingly frequently. In addition, the cross section of object 8 in the azimuth direction can be smaller than corresponding cross section 70 of localization radiation lobe 1.3, so that the reflection amplitude captured in one of second method steps 82 only reflects a section of a signal amplitude of emitted localization radiation lobe 1.3. Here, azimuth angle 74 of respective reflected localization signal 71 is preferably known from the associated localization sensor position detected by the encoder system in each case. This allows a reflection amplitude curve to be determined from the reflection amplitudes of the individual reflected localization signals and the associated localization sensor positions. The reflection amplitude profile is preferably designed to be characteristic in such a way that the second localization component in the form of the elevation angle can preferably be clearly assigned to it with a high degree of probability through correlation with the radiation characteristic. The radiation characteristic can be known from the antenna diagram of localization sensor 1.1.

Preferably, from localization signals 71 reflected by object 8, in particular based on the transit time and the phase shift between emitting the respective localization signal (first method step 80) and capturing the associated reflected localization signal (second method step 82), the distance value of reflected localization signal 71 and thus 72 of reflecting object 8 is detected. The azimuth angle of the reflecting object can be detected based on azimuth angles 74 of reflected localization signals 71 captured by means of the encoder system. This means that the position of reflecting object 8 in space can preferably clearly be detected.

Method 800 is preferably designed in such a way that in a fifth method step 90 identification radiation lobe 2.2 is emitted by means of at least one of identification sensors 2.2, 20.2. In a sixth method step 92, a radar signature of a reflected identification signal can then be captured, which can be identified in a seventh method step 94. The radar signature is preferably identified using the Doppler signature. Identifying the radar signature can in particular comprise comparing the reflected identification signals with a reference database. Preferably, fifth method step 90 to seventh method step 94 are arranged parallel to first method step 80 to fourth method step 86.

In an eighth method step 99, the reflected identification signal can be assigned to reflected localization signal 71. In order to be able to assign the reflected identification signal to reflected localization signal 71, reflecting object 8 can be at least approximately localized based on the reflected identification signal. For this purpose, the reflected identification signal is preferably processed by means of a beamforming method.

In this way, object 8 is preferably localized and identified by means of method 800 and thus comprehensively detected.

### LIST OF REFERENCE NUMERALS

1.1 first localization sensor
1.2 cover
1.3 localization radiation lobe
2.1 first identification sensor
2.2 identification radiation lobe
3.1 rotor
3.2.1 first reading head
3.2.2 second reading head
3.3.1 first localization computing unit
3.3.2 second localization computing unit
3.4 rotor-side rotary feedthrough part
3.6 axis of rotation
3.7 azimuth direction
4.1 stator
4.2 material measure
4.3.1 first identification computing unit
4.3.2 second identification computing unit
4.4 stator-side rotary feedthrough part
5 central computing unit
8 object
10.1 second localization sensor
20.1 second identification sensor
50 first localization angle
52 Localization signal curve
54 second localization angle
56 second opening angle of the localization radiation lobe
58 first opening angle of the localization radiation lobe
60 cross section of the localization radiation lobe
62 second opening angle of the identification radiation lobe
64 first opening angle of the identification radiation lobe
66 cross section of the identification radiation lobe
68 cross section of the object
70 cross section of the localization radiation lobe
71 reflected localization signal
72 distance value
74 azimuth angle of the reflected localization signal
80 first method step
82 second method step
84 third method step
86 fourth method step
90 fifth method step
92 sixth method step
94 seventh method step
99 eighth method step
100 radar system
800 method

1. A radar system (100) comprising at least one movably arranged localization sensor (1.1, 10.1) which is designed in the form of a radar sensor and comprising means for detecting the position of the at least one localization sensor (1.1, 10.1),
characterized in that
the at least one localization sensor (1.1, 10.1) has means for generating a non-homogenous radiation characteristic, said means being designed such that a localization radiation lobe (1.3) formed therewith has a signal amplitude that is based on a first localization angle (50) such that the signal amplitude has a localization signal curve (52), wherein the localization signal curve (52) is based on a second localization angle (54).

2. The radar system according to claim 1,
characterized in that
the first localization angle (50) is arranged in an azimuth direction and the second localization angle (54) is arranged in an elevation direction.

3. The radar system according to claim 1,
characterized in that
the radiation characteristic is so non-homogeneous that a correlation of the localization signal curves (52) of different second localization angles (54) results in a maximum value of less than or equal to 0.5, preferably less than or equal to 0.3, particularly preferably less than or equal to 0.1.

4. The radar system according to claim 1,
characterized in that
the means for generating a non-homogeneous radiation characteristic is formed by a cover (1.2).

5. The radar system according to claim 1,
characterized in that
the means for generating a non-homogeneous radiation characteristic is formed by a transmitting and/or receiving antenna with an antenna array with a plurality of antenna elements, the individual antenna elements being at least partially arranged at irregular distances from one another, and/or are oriented differently, and/or are at least partially arranged in different planes.

6. The radar system according to claim 1,
characterized in that
the localization radiation lobe (1.3) has a second opening angle (56) of at least 90°, preferably of at least 120°, and the ratio of the second opening angle (56) of the localization radiation lobe (1.3) to a first opening angle (58) of the localization radiation lobe (1.3) is more than 5:1, preferably more than 10:1.

7. The radar system according to claim 1,
characterized in that
the at least one localization sensor (1.1, 10.1) is arranged on a rotor (3.1), the rotor (3.1) is arranged rotatably relative to a stator (4.1), and the means for detecting a localization sensor position is designed to capture the position of the rotor (3.1) relative to the stator (4.1).

8. The radar system according claim 1,
characterized in that
the means for detecting a localization sensor position is formed by an encoder system with at least one reading head (3.2.1, 3.2.2) and a material measure (4.2).

9. The radar system according claim 1,
characterized in that
the radar system (100) has a localization computing unit (3.3.1, 3.3.2) which is designed to detect a first localization component, a second localization component and a distance value (72) of a reflected localization signal (71).

10. The radar system according to claim 9,
characterized in that
the first localization component is formed by an azimuth angle (74) and the second localization component is formed by an elevation angle.

11. The radar system according claim 1,
characterized in that
the localization computing unit (3.3.1, 3.3.2) is designed to compare a second reflected localization signal with a first reflected localization signal which has the same first localization component and to further process only differing signal components.

12. The radar system according claim 1,
characterized in that
the radar system (100) has at least one identification sensor (2.1, 20.1) for identifying an object (8), an identification radiation lobe (2.2) can be generated by means of the at least one identification sensor (2.1, 20.1) and wherein the at least one identification sensor (2.1, 20.1) is designed as a fixed radar sensor.

13. The radar system according to claim 12,
characterized in that
the identification radiation lobe (2.2) has a first opening angle (64) of at least 90°, preferably of at least 120°, and the identification radiation lobe (2.2) has a second opening angle (62) of at least 90°, preferably of at least 120°.

14. The radar system according to claim 12,
characterized in that
the at least one identification sensor (2.1, 20.1) is arranged on the stator (4.1).

15. The radar system according to claim 12,
characterized in that
the radar system (100) has at least one identification computing unit (4.3.1, 4.3.2) which is designed to identify a radar signature of a reflected identification signal.

16. The radar system according claim 12,
characterized in that
the radar system (100) has a central computing unit (5) which is designed to assign the reflected identification signal to the reflected localization signal (71).

17. (canceled)

18. (canceled)

19. (canceled)

20. (canceled)

21. (canceled)

22. (canceled)

23. (canceled)

24. (canceled)

25. (canceled)

26. (canceled)
